(19) United States
(12) Patent Application Publication
(10) Pub. No.: US 2017/0225198 A1
(43) Pub. Date: Aug. 10, 2017

(54) METHOD AND APPARATUS FOR TREATMENT OF CONTAMINATED METAL POWDER

(71) Applicant: Caterpillar Inc., Peoria, IL (US)

(72) Inventors: Daniel L. Nevarez, Nuevo Laredo (MX); David O. Villarreal, Nuevo Laredo (MX); Cesar D. Gonzalez, Nuevo Laredo (MX)

(73) Assignee: Caterpillar Inc., Peoria, IL (US)

(21) Appl. No.: 15/018,935

(22) Filed: Feb. 9, 2016

(51) Int. Cl. B07B 1/28; B22F 1/00; B33Y 40/00; B22F 3/105

(52) U.S. Cl. CPC B07B 1/28; B22F 3/1055; B22F 1/0081; B33Y 40/00; B22F 2003/1059; B33Y 10/00

(57) ABSTRACT

A method for treating a contaminated metal powder obtained as a residue of a metal deposition process is provided. The method includes receiving, by a vibratory filtering apparatus, the contaminated metal powder generated during the metal deposition process. The contaminated metal powder is received from a top end of the vibratory filtering apparatus. The method further includes filtering the contaminated metal powder by passing the contaminated metal powder through a plurality of filter plates. The plurality of filter plates are so positioned sequentially along a height of the vibratory filtering apparatus that dimensions of a first plurality of holes of a filter plate are larger than dimensions of a second plurality of holes of a subsequent filter plate placed below. The vibratory filtering apparatus is vibrating during the filtering of the contaminated metal powder. The method further includes obtaining, by a receptacle, a filtered metal powder that is reusable.

### TECHNICAL FIELD

The present disclosure relates to a treatment of contaminated metal powder, and more specifically relates to a method and an apparatus for treatment of contaminated metal powder obtained as a residue of a metal deposition process.

### BACKGROUND

Metal deposition is an additive manufacturing process that involves use of an energy source for depositing a material on a surface. For example, a Direct Metal Deposition (DMD) process is a rapid tooling process for making parts and molds from a metal powder that is melted by a laser, and then solidified on a surface. In DMD, metallic parts are manufactured directly by a machine in communication with Computer-Aided Design (CAD) data or Computer-Aided Manufacturing (CAM) data. In order to perform the metal deposition process, a work piece is usually placed in a chamber, and the aforementioned operations are then performed within the chamber.

During the metal deposition process, a significant amount of metal powder is wasted and can be spilled around within the chamber. The wasted metal powder cannot be reused as contaminants, such as chunks of deposited metal are imparted in the wasted metal powder during the metal deposition process. Since the metal powder is usually expensive, the wastage and non-reusability of the metal powder result into a significant increase in an overall cost of process.

U.S. Patent Publication Number 2014/0186205, hereinafter referred to as '205 application, describes a metal powder reconditioning apparatus and a method for reconditioning contaminated residual powder from an additive manufacturing device. The apparatus and the method include a reducing chamber that receives a contaminated residual powder resulting from an additive manufacturing process, and removes oxygen from the contaminated residual powder to produce reconditioned powder. The reconditioned powder may be reused in the additive manufacturing process, or may be stored in a non-oxidizing atmosphere for later reuse. However, the '205 application does not disclose treatment of the contaminated residual powder by vibratory filtering techniques.

### SUMMARY OF THE DISCLOSURE

In one aspect of the present disclosure, a method for treating a contaminated metal powder obtained as a residue of a metal deposition process is provided. The method includes receiving, by a vibratory filtering apparatus, the contaminated metal powder generated during the metal deposition process. The contaminated metal powder is received from a top end of the vibratory filtering apparatus. The method also includes filtering the contaminated metal powder by passing the contaminated metal powder through a plurality of filter plates. Each of the plurality of filter plates includes a plurality of holes. The plurality of filter plates are so positioned sequentially along a height of the vibratory filtering apparatus that dimensions of a first plurality of holes of a filter plate are larger than dimensions of a second plurality of holes of a subsequent filter plate placed below. The vibratory filtering apparatus is vibrating during the filtering of the contaminated metal powder. The method further includes obtaining, by a receptacle positioned at a bottom end of the vibratory filtering apparatus, a filtered metal powder, free of contaminants, that is reusable.

Other features and aspects of this disclosure will be apparent from the following description and the accompanying drawings.

### BRIEF DESCRIPTION OF THE DRAWINGS

FIG. 1 is a block diagram depicting a process of treatment of contaminated metal powder of a metal deposition process for reuse, according to an embodiment of the present disclosure;

FIG. 2 is a vibratory filtering apparatus for the treatment of the contaminated metal powder; and

FIG. 3 is a flow chart depicting a method of treatment of the contaminated metal powder.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

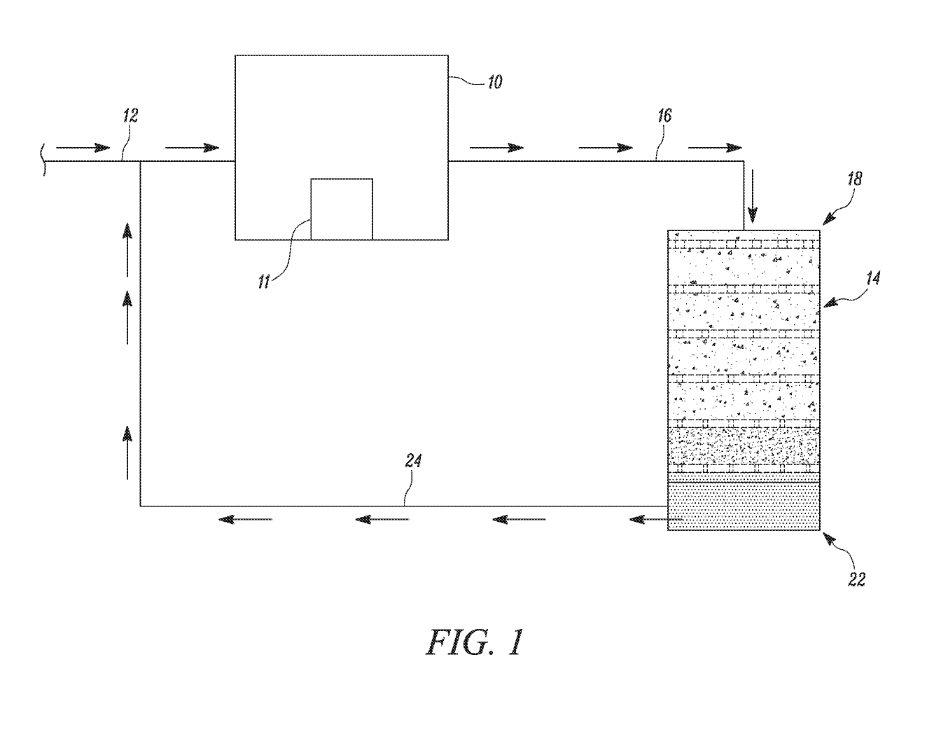

FIG. 1 illustrates a block diagram depicting a process of treatment of contaminated metal powder of a metal deposition process for reuse, according to an embodiment of the present disclosure. The material deposition process is carried out in a chamber 10. The chamber 10 has an access door 11 for enabling an operator to access the chamber 10 for managing the material deposition process. An input line 12 is shown which is indicative of a metal powder being fed to the chamber 10. It should be understood that the input line 12 is shown purely for illustrative purposes and there may be an alternative arrangement, instead of the input line 12, for feeding the metal powder into the chamber 10. The metal powder fed through the input line 12 is used for the material deposition process performed in the chamber 10.

For treating the contaminated metal powder, the contaminated metal powder is collected from the chamber 10 and fed to a vibratory filtering apparatus 14. A chamber delivery line 16 is shown which is indicative of the contaminated metal powder from the chamber 10 being fed to the vibratory filtering apparatus 14. It should be understood that the chamber delivery line 16 is shown purely for illustrative purposes and there may be an alternative arrangement, instead of the chamber delivery line 16, for feeding the contaminated metal powder to the vibratory filtering apparatus 14.

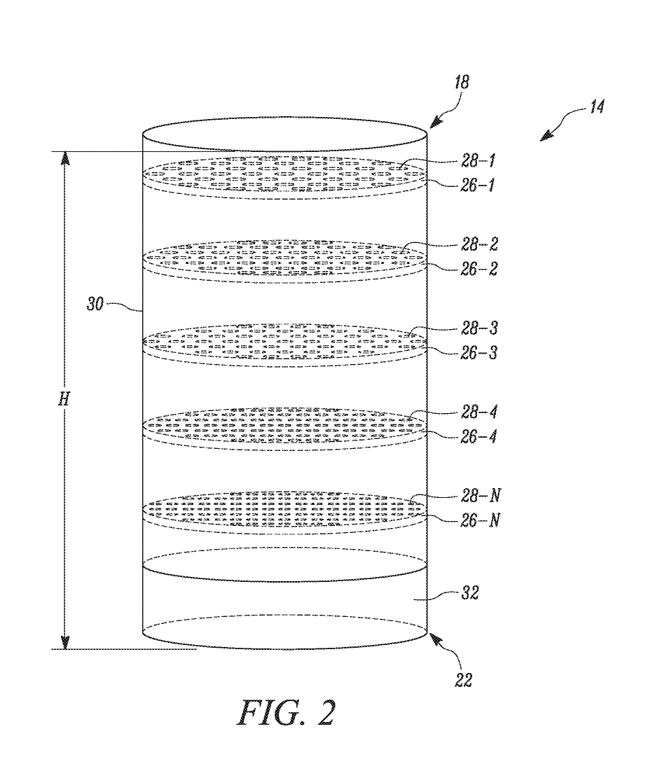

In the present embodiment, the contaminated metal powder is fed to the vibratory filtering apparatus 14 from a top end 18 of the vibratory filtering apparatus 14. The vibratory filtering apparatus 14 includes a plurality of filter plates (shown in FIG. 2) with each filter plate further including a plurality of holes. The filter plates may be arranged sequentially from the top end 18 towards a bottom end 22 of the vibratory filtering apparatus 14.

In one example, the top end 18 includes a hopper (not shown) for receiving the contaminated metal powder for treatment. In another example, the top end 18 may be an open end without the hopper. The contaminated metal powder after passing through the filter plates is filtered, and is then received at the bottom end 22 as a filtered metal powder which is free of the contaminants and the impurities. The construction and operation of the vibratory filtering apparatus 14 are explained in detail in the description of FIG. 2.

The filtered metal powder is ready to be reused and therefore, may then be fed back to the chamber 10. A filtered powder line 24 is shown which is indicative of the filtered metal powder being fed from the vibratory filtering apparatus 14 to the chamber 10. It should be understood that the filtered powder line 24 is shown purely for illustrative purposes and there may be an alternative arrangement, instead of the filtered powder line 24, for introducing the filtered metal powder into the chamber 10. Therefore, the filtered metal powder can be collected from the bottom end 22 of the vibratory filtering apparatus 14 and then can be manually fed to the chamber 10 for being reused for carrying out the metal deposition process.

Although, the reuse of the filtered metal powder is explained with respect to the metal deposition process, the filtered metal powder can be used for other operations as well, without departing from the scope of the present disclosure.

FIG. 2 illustrates the vibratory filtering apparatus 14 for the treatment of the contaminated metal powder. The vibratory filtering apparatus 14 is provided for filtering the contaminated metal powder by passing the contaminated metal powder through the filter plates 26, individually referred to as 26-1, 26-2, 26-3, . . . 26-n. The number of filter plates 26 to be used for the filtering may vary based on numerous factors, which may include, but are not limited to an extent of filtering required, a degree of contamination, and a type of the contaminated metal powder.

Each filter plate 26 further includes a plurality of holes 28, individually referred to as 28-1, 28-2, 28-3 . . . 28-n. Therefore, the holes of the filter plates 26-1, 26-2, 26-3 . . . 26-n, may be referred to as the holes 28-1, 28-2, 28-3 . . . 28-n, respectively. The holes 28 are provided on the filter plates 26 so as to block the passage of the contaminants of the contaminated metal powder through the respective filter plates 26.

The filter plates 26 are positioned sequentially within a housing 30 along a height ‘H’ of the vibratory filtering apparatus 14. As shown, the sequence of the filter plates is the filter plate 26-1, the filter plate 26-2, the filter plate 26-3, the filter plate 26-4, and so on, from the top end 18 to the bottom end 22 of the vibratory filtering apparatus 14. The filter plates 26 are positioned within the housing 30 in such a manner that the holes 28-1 of the filter plate 26-1 which is positioned near the top end 18 are larger in dimension than the holes 28-2 of the subsequent filter plate 26-2. Similarly, the dimensions of the holes 28-2 of the filter plate 26-2 are larger than dimensions of the holes 28-3 of the filter plate 26-3. Further, the dimensions of the holes 28-3 of the filter plate 26-3 are larger than dimensions of the holes 28-4 of the filter plate 26-4.

In one example, the dimensions of the holes 28 may include the diameter of the holes 28. For example, the diameter of the holes 28 decreases for the filter plates 26 positioned within the housing member 30 from the top end 18 to the bottom end 22 of the vibratory filtering apparatus 14. In one example, the diameter of the holes 28-1, 28-2, 28-3, and 28-4 may fall within a range of 100-149 microns, 120-125 microns, 140-105 microns, and 170-88 microns, respectively.

Consequently, density of the holes 28 of the filter plates 26 increases moving from the top end 18 to the bottom end 22. The density of the holes 28 of a filter plate 26 may be understood as a number of holes 28 per unit area present on the filter plate 26. Therefore, density of the holes 28-1 of the filter plate 26-1 is lesser than density of the holes 28-2 of the filter plate 26-2. Similarly, the density of the holes 28-2 of the filter plate 26-2 is lesser than density of the holes 28-3 of the filter plate 28-3. Therefore, while moving from the top end 18 to the bottom end 22, i.e., from the filter plate 26-1 to the filter plate 26-N, dimensions of the respective holes 28 decreases whereas density of the respective holes 26 increases.

While passing through the filter plates 26 so arranged, the contaminated metal powder is filtered so as to be free of the contaminants. The contaminants with larger dimensions are captured by the filter plate 26-1 considering the filter plate 26-1 has larger holes 28-1. Subsequently, contaminants with comparatively smaller dimensions are captured by the subsequent filter plates 26-2, 26-3, 26-4 . . . 26-n. The movement of the contaminated metal powder from the top end 18 to the bottom end 22 is due to gravity. During the filtering of the contaminated metal powder, the vibratory filtering apparatus 14 is vibrating to enhance the filtering of the contaminated metal powder as the vibrations would allow the contaminated metal powder to fall uniformly on the filter plates 26.

The vibratory filtering apparatus 14 includes a receptacle 32 disposed at the bottom end 22 below the filter plate 26-n. The receptacle 32 is adapted to obtain the filtered metal powder after passing through the filter plates 26, i.e., the contaminated metal powder which is now free of the contaminants. The receptacle 32 is detachable and may be removed from the vibratory filtering apparatus 14.

Although, the vibratory filtering apparatus 14 of the present disclosure is explained with respect to filtering of the contaminated metal powder obtained as a residue of the metal deposition process, the vibratory filtering apparatus 14 may be used for filtering other contaminated powders as well, without departing from the scope of the disclosure.

### INDUSTRIAL APPLICABILITY

The present disclosure relates to the vibratory filtering apparatus 14 and a method 34 for treating the contaminated metal powder obtained as a residue of the metal deposition process. During the material deposition process, most of the metal powder is deposited on a substrate layer. However, there may be a significant amount of the metal powder that may not stick to the substrate layer for deposition and therefore, may be spilled around in the chamber 10. In other words, a significant amount of the metal powder may be wasted during the material deposition process. The wasted metal powder may contain contaminants or impurities imparted in the wasted metal powder during the material deposition process. Therefore, the wasted metal powder, also referred to as contaminated metal powder, may be unfit to reuse due to the presence of contaminants or impurities. The contaminated metal powder may be understood as a residue of the material deposition process.

The vibratory filtering apparatus 14 includes the filter plates 26 which further include the holes 28. The filter plates 26 are disposed within the housing 30 along the height ‘H’ of the vibratory filtering apparatus 14. The method 34 includes receiving the contaminated metal powder by the vibratory filtering apparatus 14. Upon receiving the contaminated metal powder, the method 34 includes filtering the contaminated metal powder by passing the contaminated metal powder through the filter plates 26 disposed sequentially along the height ‘H’ of the vibratory filtering apparatus 14. The dimensions of the holes 28 of a filter plate 26 are larger than the holes 28 of the subsequent filter plate 26 placed below.

The present disclosure discloses the method 34 and the vibratory filtering apparatus 14 for filtering the contaminated metal powder obtained from the metal deposition process. However, the method 34 and the vibratory filtering apparatus 14 can further be used for filtering powders of any kind, without departing from the scope of the present disclosure. Moreover, the specification and the operational characteristics of the vibratory filtering apparatus 14 are not limited to what has been explained in the present disclosure, and can vary based on the requirements of the filtering operation to be performed, e.g., based on the powder to be filtered and the level of the filtration required.

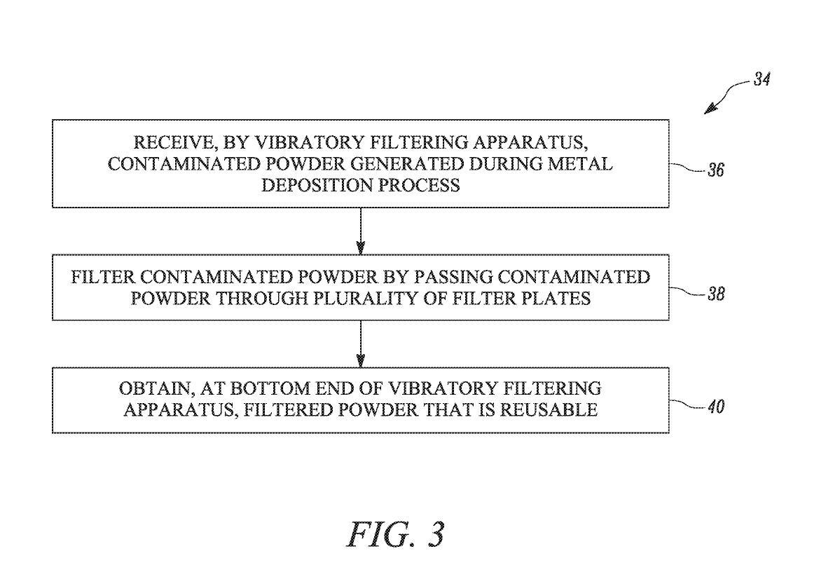

FIG. 3 illustrates a flow chart depicting the method 34 of treatment of the contaminated metal powder. For the sake of brevity, the elements of the present disclosure which are already explained in detail in previous sections are explained briefly in the description of FIG. 3. The method 34 includes, at step 36, receiving the contaminated metal powder generated as the residue of the metal deposition process. The contaminated metal powder is received from the top end 18 of the vibratory filtering apparatus 14.

At step 38, the method 34 includes filtering the contaminated metal powder. The contaminated metal powder is filtered by passing through the filter plates 26. Each filter plate 26 includes the holes 28. The filter plates 26 are disposed sequentially along the height ‘H’ of the vibratory filtering apparatus 14. The dimensions of the holes 28 of a filter plate 26 are larger than the dimensions of the holes 28 of a subsequent filter plate 26 placed below. The vibratory filtering apparatus 14 is vibrating during the filtering of the contaminated metal powder.

At step 40, the method 34 includes obtaining the filtered metal powder at the bottom end 22 of the vibratory filtering apparatus 14. The filtered metal powder is obtained by the receptacle 32 of the vibratory filtering apparatus 14. The filtered metal powder is reusable for any suitable application.

The vibratory filtering apparatus 14 and the method 34 offer an effective technique for filtering the contaminated metal powder for reuse. The sequential positioning of the filter plates 26 with decreasing dimensions and increasing density of the holes 28 from the top end 18 to the bottom end 22 of the vibratory filtering apparatus 14 results into an accurate and effective filtering of the contaminated metal powder so that a filtered metal powder that can be reused is obtained at the bottom end 22. Further, the vibratory motion of the vibratory filtering apparatus 14 assists in a better segregation of the contaminants from the contaminated metal powder. Also, the vibratory filtering apparatus 14 used in the present disclosure is simple in construction and operation. As a result, the contaminated metal powder which was otherwise considered as wastage can be reused further resulting into a cost effective operation. Therefore, the present disclosure offers the method 34 and the vibratory filtering apparatus 14 that are simple, effective, and time-saving.

While aspects of the present disclosure have been particularly shown and described with reference to the embodiments above, it will be understood by those skilled in the art that various additional embodiments may be contemplated by the modification of the disclosed machines, systems, and methods without departing from the spirit and scope of what is disclosed. Such embodiments should be understood to fall within the scope of the present disclosure as determined based upon the claims and any equivalents thereof.

What is claimed is:

1. A method for treating a contaminated metal powder obtained as a residue of a metal deposition process, the method comprising:
receiving, by a vibratory filtering apparatus, the contaminated metal powder generated during the metal deposition process, wherein the contaminated metal powder is received from a top end of the vibratory filtering apparatus;
filtering the contaminated metal powder by passing the contaminated metal powder through a plurality of filter plates, each of the plurality of filter plates includes a plurality of holes, the plurality of filter plates are so positioned sequentially along a height of the vibratory filtering apparatus that dimensions of a first plurality of holes of a filter plate are larger than dimensions of a second plurality of holes of a subsequent filter plate placed below, wherein the vibratory filtering apparatus is vibrating during the filtering of the contaminated metal powder; and
obtaining, by a receptacle positioned at a bottom end of the vibratory filtering apparatus, a filtered metal powder, free of contaminants, that is reusable.
